(19) United States
(12) Patent Application Publication
(10) Pub. No.: US 2025/0300439 A1
(43) Pub. Date: Sep. 25, 2025

(54) WIRE STRIPPER

(71) Applicant: FIST WAY INDUSTRIAL CO., LTD., Changhua City (TW)

(72) Inventor: CHEN-SHENG YANG, Changhua City (TW)

(21) Appl. No.: 18/611,489

(22) Filed: Mar. 20, 2024

(51) Int. Cl. H02G 1/12

(52) U.S. Cl. CPC H02G 1/1212

(57) ABSTRACT

A wire stripper may include a tool body which has two handles, and the two handles are pivotally connected at the intersection with a pivot axis, and each of the handles comprises a head portion at the top thereof. The head portion is perpendicular to the handle to form a T-shape. The two head portions respectively have a first crimping portion and a second crimping portion at the inner side of the junction of the head portion and the handle, and the first crimping portion and the second crimping portion are formed as a groove and a ridge so as to crimp cable wire. Each of the head portions has a serrated clamping portion at the inner side of the front end thereof for clamping cable wire.

### FIELD OF THE INVENTION

The present invention relates to a wire stripper and more particularly to a wire stripper with comprehensive functions and easier to use.

### BACKGROUND OF THE INVENTION

In the field of electrical work, maintaining wire often involves cutting and stripping them to expose the intact wire beneath the insulation. To connect wires, one common method is to dispose a tubular structure on the wire and then perform crimping so as to join terminals or connecting wires together.

Referring to FIGS. 8 to 10, two first jaw portions (81) are pivotally connected to form a first tool (80), and a stripping portion (A) is formed on the inner side of the first jaw portion (81) while the outer side of the first jaw portion (81) is vertically equipped with a first tool head (82), and the first tool head (82) comprises a clamping portion (B) and a crimping portion (C). Referring to FIGS. 11 to 13, two second jaw portions (91) are pivotally connected to form a second tool (90), and a crimping portion (C) is formed on the inner side of the second jaw portion (91) while the outer side of the second jaw portion (91) is vertically equipped with a second tool head (92) having a stripping portion (A) and a cutting portion (D). By utilizing the first tool (80) and the second tool (90), the stripping portion (A), the clamping portion (B), the crimping portion (C), the cutting portion (D) can achieve the functions of stripping, clamping, crimping and cutting of cable wire, so as to meet the requirements in the field of electrical work. Also, the first tool head (82) and the second tool head (92) are respectively formed perpendicular to the first jaw portion (81) and the second jaw portion (91), allowing for a change in the direction of force application in relatively narrow spaces. Otherwise, with conventional wire cutters or wire strippers, the working ends along with the handles may be too long, making it difficult to apply force in tight spaces.

However, the conventional wire stripper has following disadvantages: when users need to switch functions, continuous adjustment of the angles of the first tool (80) and the second tool (90) is required for usability, and it becomes challenging to use in narrow spaces when the stripping portion (A) and the crimping portion (C) are located on the inner side of the first tool (80) and the second tool (90), so that the first tool (80) and the second tool (90) may be interactively used, causing inconvenience for users. Therefore, there remains a need for a new and improved design for a wire stripper to overcome the problems presented above.

### SUMMARY OF THE INVENTION

The present invention provides a wire stripper comprising a tool body which has two handles, and the two handles are pivotally connected at the intersection with a pivot axis, and each of the handles comprises a head portion at the top thereof. The head portion is perpendicular to the handle to form a T-shape. The two head portions respectively have a first crimping portion and a second crimping portion at the inner side of the junction of the head portion and the handle, and the first crimping portion and the second crimping portion are formed as a groove and a ridge so as to crimp cable wire. Each of the head portions has a serrated clamping portion at the inner side of the front end thereof for clamping cable wire. A plurality of concaved arc-shaped stripping portions with different sizes, which are formed symmetrically on the two head portions between the clamping portion and the first crimping portion and between the clamping portion and the second crimping portion respectively, are used to strip the insulation layer from cable wire. A blade portion and a block portion are respectively formed on two head portions at the rear ends thereof, so as to form a blade and a flat surface respectively for cutting cable wire.

The first crimping portion and the blade portion are formed on one head portion while the second crimping portion and the block portion are formed on the other head portion.

Comparing with conventional wire stripper, the present invention is advantageous because: (i) the first crimping portion, the second crimping portion, the clamping portion, the stripping portion, the blade portion, and the block portion are formed on the head portions and used in the same direction, so that the user has no need to frequently adjust the usage angle of the tool body, making it more convenient to use; (ii) the first crimping portion, the second crimping portion, the clamping portion, the stripping portion, the blade portion, and the block portion are not formed on the handles, so that the length of the handle ensures that the wire stripper of the present invention is adapted to be used effectively in narrow spaces without hindering the operations of crimping clamping, stripping and cutting; and (iii) the head portion is perpendicular to the handle to form a T-shape, which effectively utilize space, so that the first crimping portion, the second crimping portion, the clamping portion, the stripping portion, the blade portion, and the block portion are configured to be formed on the head portions to provide comprehensive functions, so as to allow the user perform various tasks with one single tool body, enhance operational convenience, and save on toll expenses.

### BRIEF DESCRIPTION OF THE DRAWINGS

FIG. 1 is a three-dimensional assembly view of a wire stripper of the present invention.

FIG. 2 is a three-dimensional exploded view of the wire stripper of the present invention.

FIG. 3 is a top view of the wire stripper of the present invention.

FIG. 4 is a lateral view of the wire stripper of the present invention.

FIG. 5 is a front view of the wire stripper of the present invention.

FIG. 6 is a schematic view illustrating the wire stripper of the present invention at the opening state.

FIG. 7 is a schematic view illustrating the wire stripper of the present invention is in use.

FIG. 8 is a prior art.

FIG. 9 is a prior art.

FIG. 10 is a prior art.

FIG. 11 is a prior art.

FIG. 12 is a prior art.

FIG. 13 is a prior art.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

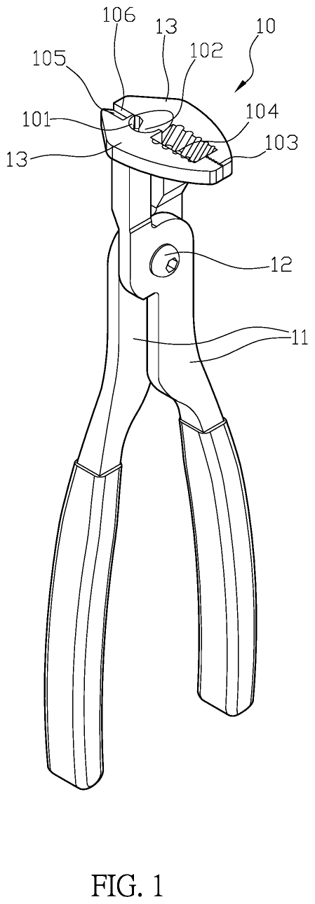

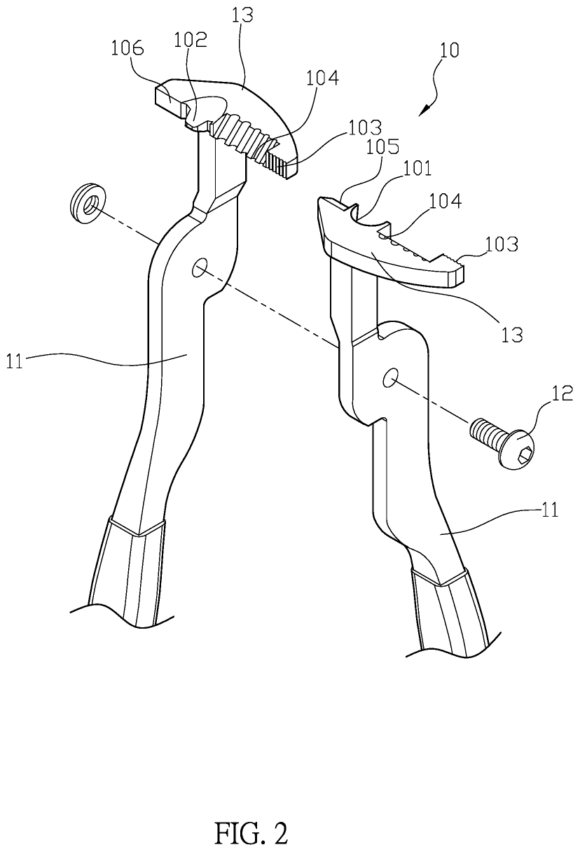

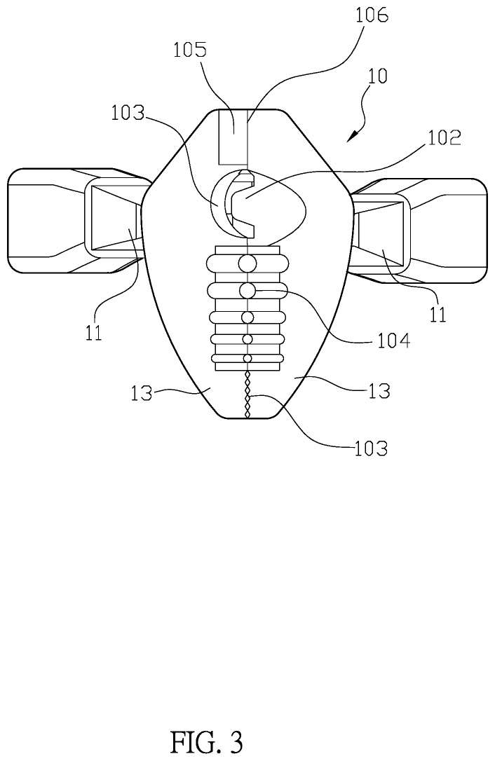

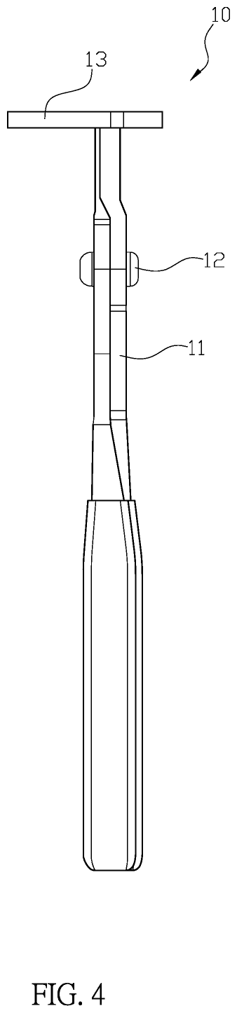

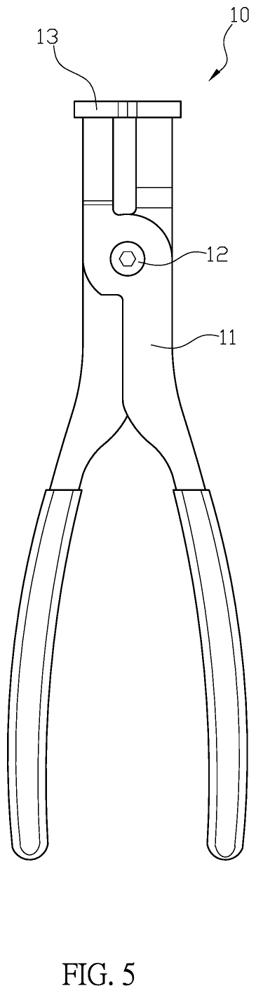

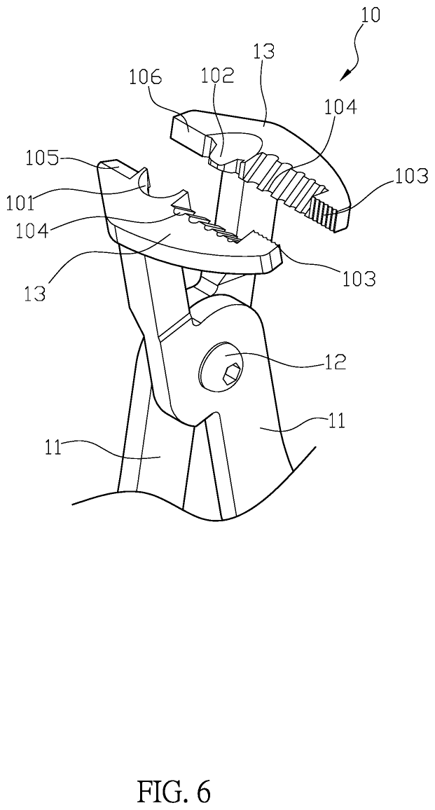

Referring to FIGS. 1 to 6, the present invention provides a wire stripper comprising a tool body (10) which has two handles (11), and the two handles (11) are pivotally connected at the intersection with a pivot axis (12), and each of the handles (11) comprises a head portion (13) at the top thereof. Also, the head portion (13) is perpendicular to the handle (11) to form a T-shape. The two head portions (13) respectively have a first crimping portion (101) and a second crimping portion (102) at the inner side of the junction of the head portion (13) and the handle (11), and the first crimping portion (101) and the second crimping portion (102) are formed as a groove and a ridge so as to crimp cable wire. Each of the head portions (13) has a serrated clamping portion (103) at the inner side of the front end thereof for clamping cable wire. A plurality of concaved arc-shaped stripping portions (104) with different sizes, which are formed symmetrically on the two head portions (13) between the clamping portion (103) and the first crimping portion (101) and between the clamping portion (103) and the second crimping portion (102) respectively, are used to strip the insulation layer from cable wire. Moreover, a blade portion (105) and a block portion (106) are respectively formed on two head portions (13) at the rear ends thereof, so as to form a blade and a flat surface respectively for cutting cable wire.

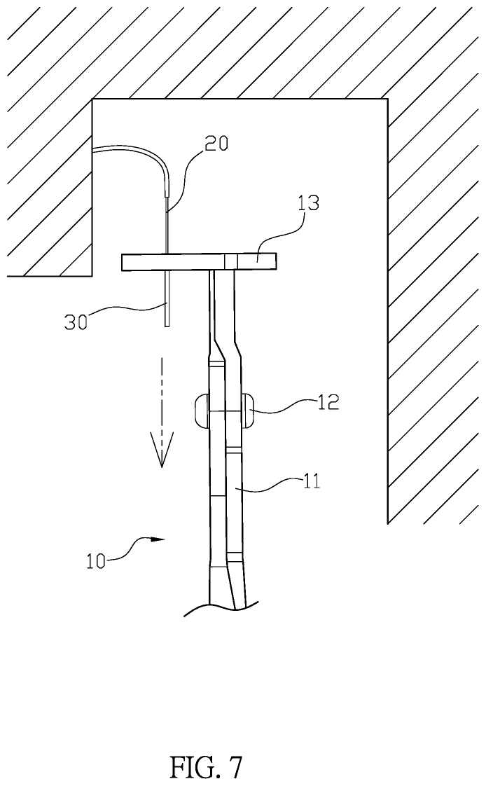

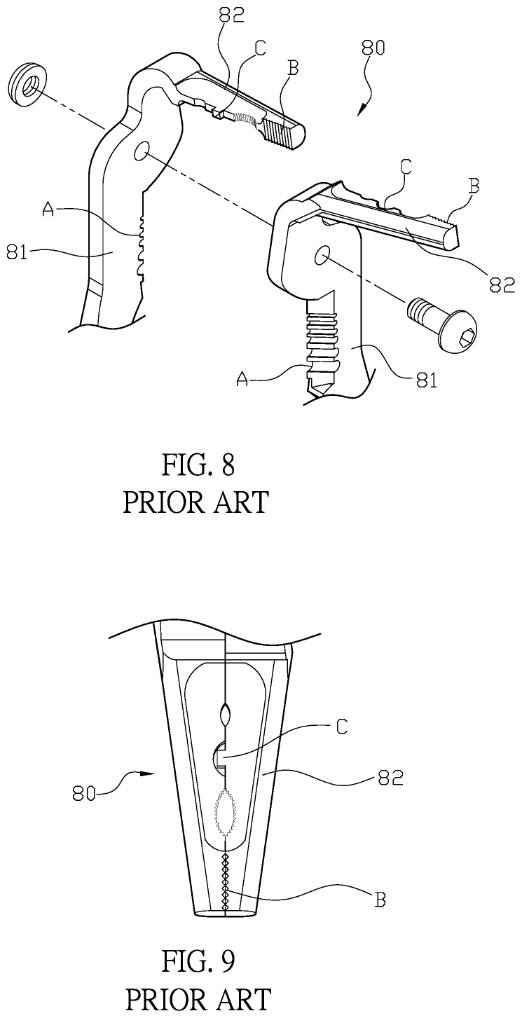

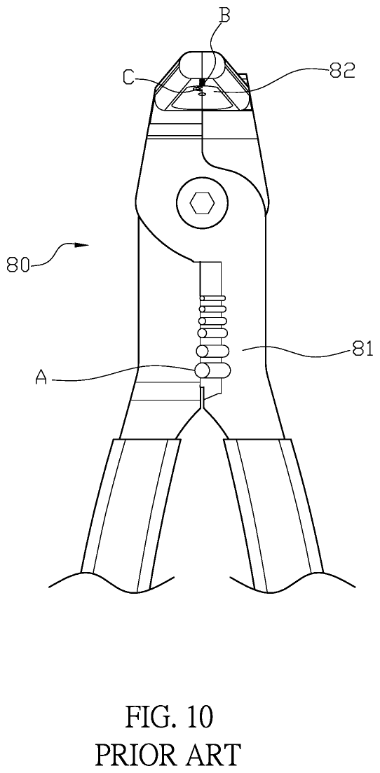

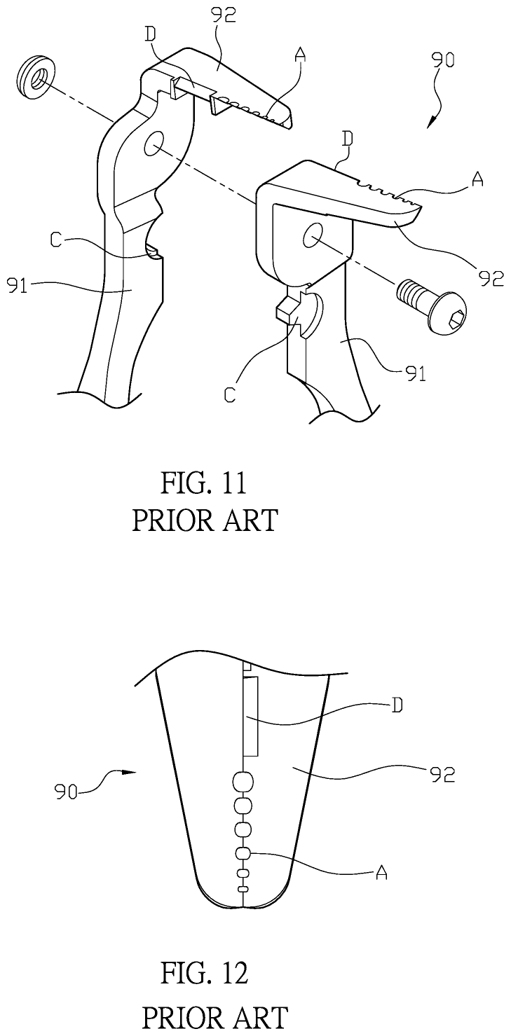

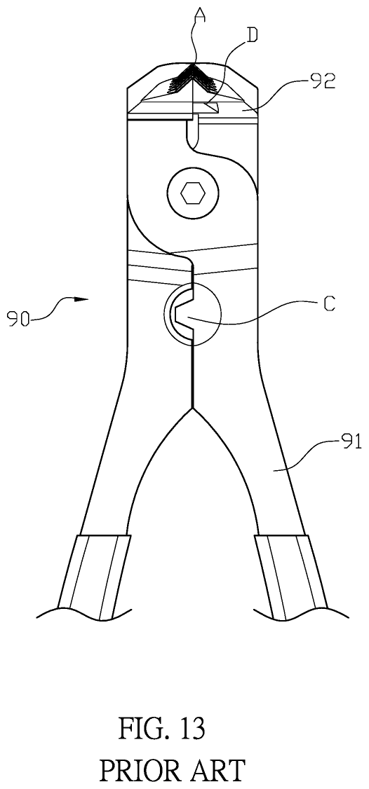

In actual application, the user is adapted to operate the handles (11) to bring the head portions (13) close to each other so as to achieve the crimping action by the first crimping portion (101) and the second crimping portion (102). Furthermore, when crimping terminals or disposing a tube around two cable wires, the concaved first crimping portion (101) is configured to serve as a support while the second crimping portion (102) is a ridge to press against the crimping terminal or tube, causing deformation and completing the crimping process. The serrated clamping portions (103) of the head portions (13) are brought close together, so as to grip cable wire, and the arc-shaped stripping portions (104) brought close to each other are adapted to shear the insulation layers from cable wires, and the insulation layers are stripped away from cable wires by moving the tool body (10). Referring to FIG. 7, the stripping portions (104) of the head portions (13) are adapted to push an insulating cover (30) of a wire (20) and move downward to strip the insulating cover (30) from the wire (20). The block portion (106) is a flat surface which allows cable wire to be supported, while the blade portion (105) is adapted to approach and cut cable wire. Thus, the tool body (10) is configured to perform the functions of crimping clamping, stripping and cutting.

In one embodiment, the first crimping portion (101) and the blade portion (105) are formed on one head portion (13) while the second crimping portion (102) and the block portion (106) are formed on the other head portion (13) so as to achieve the balance between the support point and the force application point.

In another embodiment, the head portion (13) and the handle (11) are integrally formed through casting, forging and milling processes.

In still another embodiment, the head portion (13) and the handle (11) are connected through welding process.

In a further embodiment, the head portion (13) and the handle (11) are connected through screw-locking method.

In still a further embodiment, the total length of the head portion (13) is equal to the height from the bottom surface of the head portion (13) to the center of the pivot axis (12), so that the head portion (13) is configured to access narrow areas.

Comparing with conventional wire stripper, the present invention is advantageous because: (i) the first crimping portion (101), the second crimping portion (102), the clamping portion (103), the stripping portion (104), the blade portion (105), and the block portion (106) are formed on the head portions (13) and can be used in the same direction, so that the user has no need to frequently adjust the usage angle of the tool body (10), making it more convenient to use; (ii) the first crimping portion (101), the second crimping portion (102), the clamping portion (103), the stripping portion (104), the blade portion (105), and the block portion (106) are not formed on the handles (11), so that the length of the handle (11) ensures that the wire stripper of the present invention can be used effectively in narrow spaces without hindering the operations of crimping clamping, stripping and cutting; and (iii) the head portion (13) is perpendicular to the handle (11) to form a T-shape, which effectively utilize space, so that the first crimping portion (101), the second crimping portion (102), the clamping portion (103), the stripping portion (104), the blade portion (105), and the block portion (106) can be formed on the head portions (13) to provide comprehensive functions, so as to allow the user perform various tasks with one single tool body (10), enhance operational convenience, and save on toll expenses.

Moreover, referring to FIG. 7, the user can use the tool body (10) to access narrow spaces, such as gaps in ceilings or under furniture, and due to the perpendicular T-shaped configuration of the head with the handle (11), force can be uniformly applied in the parallel direction of the handle (11) so as to avoid the need for frequent directional adjustment and get stuck in tight spaces.

In addition, the clamping portion (103), and the blade portion (105) and the block portion (106) are respectively located at the front end and the rear end of the head portions (13) so as to achieve the effect of the clamping and cutting cable wire, and the stripping portion (104) is adapted to pull and remove the insulation layer of cable wire so as to locate between the clamping portions (103) and the first crimping portion (101) and the second crimping portion (102) so as to facilitate the pulling and striping of the insulation layer. Also, the first crimping portion (101) and the second crimping portion (102) used for crimping are located on the inner side at the junction between the two head portions (13) and the handles (11), so as to effectively utilize the overlapping section of the handles (11). The first crimping portion (101) and the second crimping portion (102) are formed on the same plane as the holding portion of the handles (11) so as to maximize the leverage effect, thereby achieving the effect of labor-saving.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A wire stripper comprising a tool body;
wherein the tool body has two handles which are pivotally connected at the intersection with a pivot axis, and each of the handles comprises a head portion at the top thereof; the head portion is perpendicular to the handle to form a T-shape; the two head portions respectively have a first crimping portion and a second crimping portion at the inner side of the junction of the head portion and the handle, and the first crimping portion and the second crimping portion are formed as a groove and a ridge so as to crimp cable wire; each of the head portions has a serrated clamping portion at the inner side of the front end thereof for clamping cable wire; a plurality of concaved arc-shaped stripping portions with different sizes, which are formed symmetrically on the two head portions between the clamping portion and the first crimping portion and between the clamping portion and the second crimping portion respectively, are used to strip the insulation layer from cable wire; a blade portion and a block portion are respectively formed on two head portions at the rear ends thereof, so as to form a blade and a flat surface respectively for cutting cable wire.

2. The wire stripper of claim 1, wherein the first crimping portion and the blade portion are formed on one head portion while the second crimping portion and the block portion are formed on the other head portion.

3. The wire stripper of claim 1, wherein the head portion and the handle are integrally formed.

4. The wire stripper of claim 1, wherein the head portion and the handle are formed separately.

5. The wire stripper of claim 1, wherein the total length of the head portion is equal to the height from the bottom surface of the head portion to the center of the pivot axis.
